(19) United States
(12) Patent Application Publication
(10) Pub. No.: US 2017/0161928 A1
(43) Pub. Date: Jun. 8, 2017

(54) Method and Electronic Device for Displaying Virtual Device Image

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Bo HUANG, Tianjin (CN)

(21) Appl. No.: 15/246,530

(22) Filed: Aug. 24, 2016

Related U.S. Application Data
(63) Continuation of application No. PCT/CN2016/089474, filed on Jul. 8, 2016.

(30) Foreign Application Priority Data
Dec. 4, 2015 (CN) 201510884219.7

(51) Int. Cl. G06T 11/60; G06K 9/62

(52) U.S. Cl. CPC G06T 11/60; G06K 9/6215; G06T 2210/04

(57) ABSTRACT

Disclosed are a method and an electronic device for displaying a virtual device image. The method includes: first of all acquiring live-action data corresponding to a placement location of a virtual device image and a data display characteristic value corresponding to the live-action data; then determining whether a preset data display characteristic value exists in a preset storage location, wherein a similarity between the data display characteristic value and the preset data display characteristic value is less than or equal to a preset threshold, and acquiring a virtual device image having a preset size corresponding to the preset data display characteristic value from the preset storage location when the preset data display characteristic value exists; and finally carrying out a superposition display of the live-action data and the virtual device image and displaying preset size information corresponding to the virtual device image.

### CROSS REFERENCE TO RELATED APPLICATIONS

This application is a continuation of International Application No. PCT/CN2016/089474, filed on Jul. 8, 2016, which is based upon and claims priority to Chinese Patent Application No. 201510884219.7, filed on Dec. 4, 2015, the entire contents of all of which are incorporated herein by reference.

### TECHNICAL FIELD

The present disclosure relates to information technologies, and more particularly, to a method and an electronic device for displaying a virtual device image.

### BACKGROUND

With the constant development of information technologies, functions of terminal devices become more and more powerful. Household appliances such as television sets, electric refrigerators and washing machines or the like have become appliances indispensable to people in everyday life.

In family life, people may select corresponding household appliances according to sizes of living rooms such as sitting rooms or bedrooms, for example, when people by television sets, generally they artificially inquire a seller of sizes of to-be-configured television sets on an online store or a physical store. However, in a process of implementing the present disclosure, it is found that because users have different feelings and different preferences to sizes and shapes, they may find that sizes of devices are unfitted after the devices are bought and placed at home, which may cause unnecessary waste of resources.

### SUMMARY

The present disclosure provides a method and an electronic device for displaying a virtual device image to solve a problem in the prior art that lower device size configuration precision and waste of resources are caused by artificially inquiring a seller of a size of a to-be-configured device on an online store or a physical store.

In a first aspect, embodiments of the present disclosure provide a method for displaying a virtual device image, implemented by an electronic device, including:

acquiring live-action data corresponding to a placement location of a virtual device image and a data display characteristic value corresponding to the live-action data;

determining whether a preset data display characteristic value exists in a preset storage location, wherein a similarity between the data display characteristic value and the preset data display characteristic value is less than or equal to a preset threshold, and the preset storage location saves different preset data display characteristic values and virtual device images having different preset sizes respectively corresponding to the different preset data display characteristic values;

acquiring a virtual device image having a preset size corresponding to the preset data display characteristic value from the preset storage location when the preset data display characteristic value exists; and

carrying out a superposition display of the live-action data and the virtual device image and displaying preset size information corresponding to the virtual device image.

In a second aspect, embodiments of the present disclosure provide a non-transitory computer-readable storage medium storing executable instructions, wherein the executable instructions are configured to perform any methods for displaying a virtual device image mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for displaying a virtual device image mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for displaying a virtual device image in accordance with some embodiments;

FIG. 2 is a flow chart of another method for displaying a virtual device image in accordance with some embodiments;

FIG. 3 is a schematic structural diagram of an apparatus for displaying a virtual device image in accordance with some embodiments;

FIG. 4 is a schematic structural diagram of another apparatus for displaying a virtual device image in accordance with some embodiments; and

FIG. 5 is a block diagram of an electronic device which is configured to perform the methods for displaying a virtual device image in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

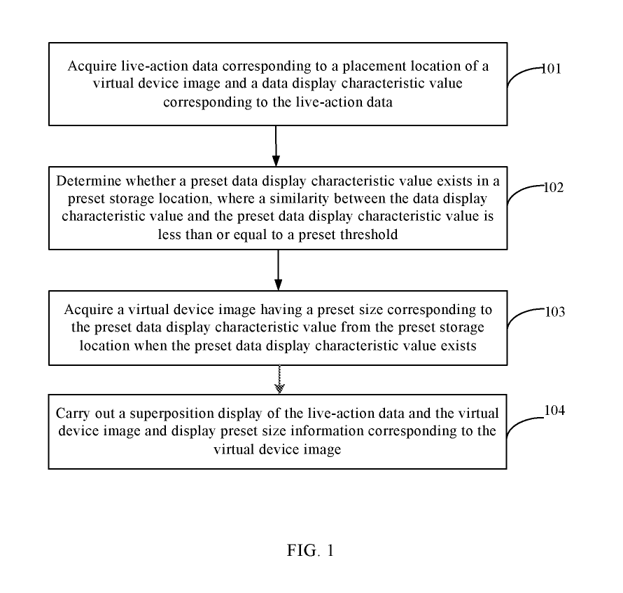

Embodiments of the present disclosure provide a method for displaying a virtual device image, which can be applied to a terminal device such as a mobile phone, a computer, a personal computer or the like, as shown in FIG. 1, the method includes:

101: live-action data corresponding to a placement location of a virtual device image and a data display characteristic value corresponding to the live-action data are acquired.

The virtual device can be a household appliance such as a television set, a washing machine, an electric refrigerator and so on, and live-action data corresponding to a placement location of a virtual device image specifically can be a live-action image of a television cabinet in a sitting room or a bedroom or a live-action image of a location area where a television set is hung, which are not limited in embodiments of the present disclosure. For example, when a shooting instruction is received, live-action data can be acquired by means of a preset camera. The data display characteristic value is used for marking a specific display position and a size of live-action data. The data display characteristic value specifically can be a gray value and/or a contrast value of data display, which is not limited in the embodiments of the present disclosure. Gray values and/or contrast values corresponding to different positions and different sizes may also be different. Therefore, a specific position and a specific size of live-action data can be reflected through a gray value and/or a contrast value. Each image datum respectively corresponds to one or one group of gray values and/or contrast values.

102: It is determined whether a preset data display characteristic value exists in a preset storage location, where a similarity between the data display characteristic value and the preset data display characteristic value is less than or equal to a preset threshold.

The preset storage location saves different preset data display characteristic values and virtual device images having different preset sizes respectively corresponding to the different preset data display characteristic values. The preset threshold can be configured according to actual demands, which is not limited in the embodiments of the present disclosure. For example, when a requirement for an accuracy of superposed data is relatively high, the preset threshold can be configured relatively small. However, when the requirement for the accuracy of superposed data is not high, the preset threshold can be configured relatively large. To television sets, different preset sizes can be common sizes such as 24-inch, 32-inch, 50-inch or the like. Since different preset data display characteristic values can reflect positions and sizes of placed devices, virtual device images having different preset sizes are respectively configured for different preset data display characteristic values, which can ensure that a device that needs to be placed is matched with a position where the device is placed.

103: A virtual device image having a preset size corresponding to the preset data display characteristic value is acquired from the preset storage location when the preset data display characteristic value exists.

The virtual device image having a preset size is a three-dimensional virtual image that really reflects a real device having this size. For example, to a 24-inch television set, the image is a three-dimensional virtual image that really reflects the 24-inch television set. To the embodiments of the present disclosure, by acquiring a virtual device image having a preset size corresponding to the preset data display characteristic value, it can be ensured that a device that needs to be placed is matched with a position where the device is placed.

104: A superposition display of the live-action data and the virtual device image is carried out and preset size information corresponding to the virtual device image is displayed.

A position of displaying the preset size information corresponding to the virtual device image can be on the virtual device image or outside the virtual device image, which is not limited in the embodiments of the present disclosure. For example, if a virtual device is a 24-inch television set, the television set and a virtual image thereof are marked as 24-inch in size when a superposition display of the live-action data and the virtual image of the 24-inch television set is carried out.

According to a method for displaying a virtual device image provided by embodiments of the present disclosure, first of all, live-action data corresponding to a placement location of a virtual device image and a data display characteristic value corresponding to the live-action data are acquired, then it is determined whether a preset data display characteristic value exists in a preset storage location, where a similarity between the data display characteristic value and the preset data display characteristic value is less than or equal to a preset threshold, a virtual device image having a preset size corresponding to the preset data display characteristic value is acquired from the preset storage location when the preset data display characteristic value exists, and finally a superposition display of the live-action data and the virtual device image is carried out and preset size information corresponding to the virtual device image is displayed. Compared with artificially inquiring a seller of a size of a to-be-configured television set on an online store or a physical store at present, in the embodiments of the present disclosure, a virtual television image matched with a current scene size is automatically acquired, and a superposed effect and a specific size are presented, in this way, a device size configuration precision can be improved and unnecessary waste of resources can be reduced.

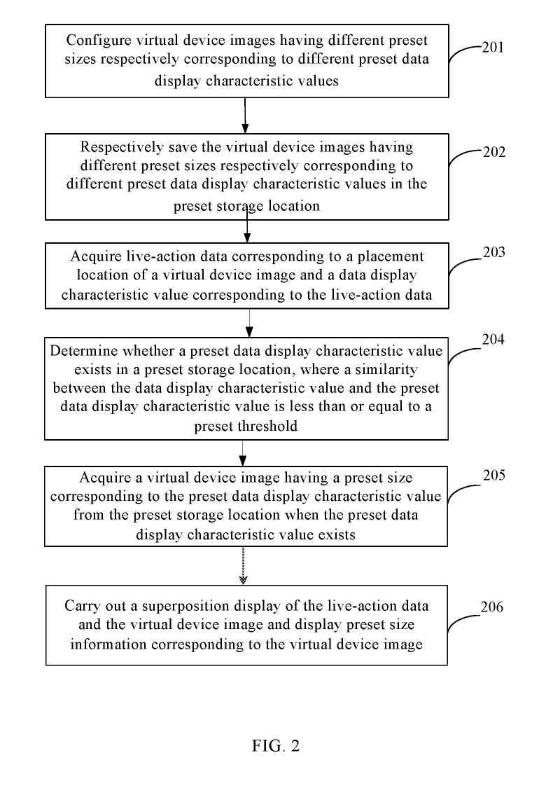

Embodiments of the present disclosure provide another method for displaying a virtual device image, which can be applied to a terminal device such as a mobile phone, a computer, a personal computer or the like, as shown in FIG. 2, the method includes:

201: Virtual device images having different preset sizes respectively corresponding to different preset data display characteristic values are configured.

The preset data display characteristic value is used for marking a specific display position and a size of live-action data. The data display characteristic value specifically can be a gray value and/or a contrast value of data display, which is not limited in the embodiments of the present disclosure. Gray values and/or contrast values corresponding to different positions and different sizes may also be different. Therefore, a specific position and a specific size of live-action data can be reflected through a gray value and/or a contrast value. By respectively configuring virtual device images having different preset sizes for different preset data display characteristic values, it can be ensured that a device that needs to be placed is matched with a position where the device is placed.

202: The virtual device images having different preset sizes respectively corresponding to different preset data display characteristic values are respectively saved in the preset storage location.

The preset storage location can be a hard disk, a memory, a buffer memory or the like, which is not limited in the embodiments of the present disclosure.

203: live-action data corresponding to a placement location of a virtual device image and a data display characteristic value corresponding to the live-action data are acquired.

The virtual device can be a household appliance such as a television set, a washing machine, an electric refrigerator and so on, and live-action data corresponding to a placement location of a virtual device image specifically can be a live-action image of a television cabinet in a sitting room or a bedroom or a live-action image of a location area where a television set is hung, which are not limited in embodiments of the present disclosure.

204: It is determined whether a preset data display characteristic value exists in a preset storage location, where a similarity between the data display characteristic value and the preset data display characteristic value is less than or equal to a preset threshold.

The preset threshold can be configured according to actual demands, which is not limited in the embodiments of the present disclosure. For example, when a requirement for accuracy of superposed data is relatively high, the preset threshold can be configured relatively small. However, when the requirement for the accuracy of superposed data is not high, the preset threshold can be configured relatively large. To television sets, different preset sizes can be 20-inch, 52-inch, and 60-inch, etc.

205: A virtual device image having a preset size corresponding to the preset data display characteristic value is acquired from the preset storage location when the preset data display characteristic value exists.

The virtual device image having a preset size is a three-dimensional virtual image that really reflects a real device having this size. For example, to a 32-inch television set, the image is a three-dimensional virtual image that really reflects the 32-inch television set. To the embodiments of the present disclosure, by acquiring a virtual device image having a preset size corresponding to the preset data display characteristic value, it can be ensured that a device that needs to be placed is matched with a position where the device is placed.

206: A superposition display of the live-action data and the virtual device image is carried out and preset size information corresponding to the virtual device image is displayed.

A position for displaying the preset size information corresponding to the virtual device image can be on the virtual device image or outside the virtual device image, which is not limited in the embodiments of the present disclosure. For example, if a virtual device is a 32-inch television set, the television set and a virtual image thereof are marked as 32-inch in size when a superposition display of the live-action data and the virtual image of the 32-inch television set is carried out.

To the embodiments of the present disclosure, before Step 205, the method may further include: adjusting the virtual device image according to the data display characteristic value corresponding to the live-action data and shooting angle information corresponding to the live-action data. Specifically, when the data display characteristic value corresponding to the live-action data is a gray value, a live-action data image can be divided into different areas according to the gray value, and then a displayed virtual device image is rotated according to a relation between a shooting position corresponding to the live-action data and positions among different areas. For example, if the shooting position corresponding to the live-action data is a back side of the live-action data image, a back face of the virtual device image is displayed, and if the shooting position corresponding to the live-action data is a front side of the live-action data image, a front face of the virtual device image is displayed, which is not limited in the embodiments of the present disclosure. In this case, Step 205 specifically can include: carrying out a superposition display of the live-action data and the adjusted virtual device image. By adjusting the virtual device image, data obtained after superposing the live-action data and the virtual device image can more really reflect conditions of a physical device, and further improve a device size configuration precision.

Further, when a virtual device image size switching instruction is received, a virtual device image corresponding to size information indicated in the switching instruction is acquired from the preset storage location, and a superposition display of the live-action data and the virtual device image is carried out. To the embodiments of the present disclosure, by providing a device size switching function for users, experiences of users having different requirements for device sizes can be met, and device size configuration flexibility can be improved.

To the embodiments of the present disclosure, the preset storage location further saves model marking information respectively corresponding to virtual device images having different preset sizes, where the model marking information is used for marking different device models, for example, devices with a certain size can have different device models. In this case, when a virtual device image model switching instruction is received, a virtual device image corresponding to model marking information indicated in the switching instruction is acquired from the preset storage location, and a superposition display of the live-action data and the virtual device image is carried out. By providing a device model switching function for users, experiences of users having different requirements for device models can be met, and a device configuration precision can be further improved.

According to another method for displaying a virtual device image provided by embodiments of the present disclosure, first of all, live-action data corresponding to a placement location of a virtual device image and a data display characteristic value corresponding to the live-action data are acquired, then it is determined whether a preset data display characteristic value exists in a preset storage location, where a similarity between the data display characteristic value and the preset data display characteristic value is less than or equal to a preset threshold, a virtual device image having a preset size corresponding to the preset data display characteristic value is acquired from the preset storage location when the preset data display characteristic value exists, and finally a superposition display of the live-action data and the virtual device image is carried out and preset size information corresponding to the virtual device image is displayed. Compared with artificially inquiring a seller of a size of a to-be-configured television set on an online store or a physical store at present, in the embodiments of the present disclosure, a virtual television image matched with a current scene size is automatically acquired, and a superposed effect and a specific size are presented, in this way, a device size configuration precision can be improved and unnecessary waste of resources can be reduced.

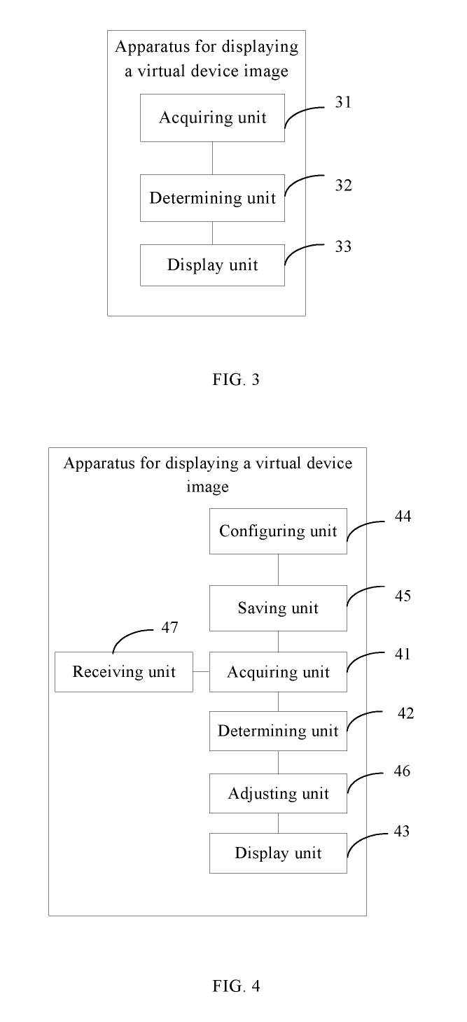

Further, as a concrete implementation of the method as shown in FIG. 1, embodiments of the present disclosure provide an apparatus for displaying a virtual device image, as shown in FIG. 3, the apparatus for displaying a virtual device image includes: an acquiring unit 31, a determining unit 32 and a display unit 33.

The acquiring unit 31 is configured to acquire live-action data corresponding to a placement location of a virtual device image and a data display characteristic value corresponding to the live-action data.

The determining unit 32 is configured to determine whether a preset data display characteristic value exists in a preset storage location, where a similarity between the data display characteristic value and the preset data display characteristic value is less than or equal to a preset threshold, and the preset storage location saves different preset data display characteristic values and virtual device images having different preset sizes respectively corresponding to the different preset data display characteristic values.

The acquiring unit 31 is further configured to acquire a virtual device image having a preset size corresponding to the preset data display characteristic value from the preset storage location when the preset data display characteristic value exists.

The display unit 33 is configured to carry out a superposition display of the live-action data and the virtual device image and display a preset size corresponding to the virtual device image.

It is to be noted that reference can be made to corresponding description of the method as shown in FIG. 1 for other corresponding description of various function units involved with the apparatus for displaying a virtual device image provided by embodiments of the present disclosure, which is not unnecessarily elaborated any more herein.

An apparatus for displaying a virtual device image provided by embodiments of the present disclosure first of all acquires live-action data corresponding to a placement location of a virtual device image and a data display characteristic value corresponding to the live-action data, then determines whether a preset data display characteristic value exists in a preset storage location, where a similarity between the data display characteristic value and the preset data display characteristic value is less than or equal to a preset threshold, acquires a virtual device image having a preset size corresponding to the preset data display characteristic value from the preset storage location when the preset data display characteristic value exists, and finally carries out a superposition display of the live-action data and the virtual device image and displays preset size information corresponding to the virtual device image. Compared with artificially inquiring a seller of a size of a to-be-configured television set on an online store or a physical store at present, in the embodiments of the present disclosure, a virtual television image matched with a current scene size is automatically acquired, and a superposed effect and a specific size are presented, in this way, a device size configuration precision can be improved and unnecessary waste of resources can be reduced.

Further, as a concrete implementation of the method as shown in FIG. 2, embodiments of the present disclosure provide another apparatus for displaying a virtual device image, as shown in FIG. 4, the apparatus for displaying a virtual device image includes: an acquiring unit 41, a determining unit 42 and a display unit 43.

The acquiring unit 41 is configured to acquire live-action data corresponding to a placement location of a virtual device image and a data display characteristic value corresponding to the live-action data.

The determining unit 42 is configured to determine whether a preset data display characteristic value exists in a preset storage location, where a similarity between the data display characteristic value and the preset data display characteristic value is less than or equal to a preset threshold, and the preset storage location saves different preset data display characteristic values and virtual device images having different preset sizes respectively corresponding to the different preset data display characteristic values.

The acquiring unit 41 is further configured to acquire a virtual device image having a preset size corresponding to the preset data display characteristic value from the preset storage location when the preset data display characteristic value exists.

The display unit 43 is configured to carry out a superposition display of the live-action data and the virtual device image and display a preset size corresponding to the virtual device image.

Further, the apparatus further includes:

a configuring unit 44, configured to configure virtual device images having different preset sizes respectively corresponding to different preset data display characteristic values; and

a saving unit 45, configured to respectively save the virtual device images having different preset sizes respectively corresponding to different preset data display characteristic values in the preset storage location.

Further, the apparatus further includes:

an adjusting unit 46, configured to adjust the virtual device image according to the data display characteristic value corresponding to the live-action data and shooting angle information corresponding to the live-action data.

Further, the apparatus further includes: a receiving unit 47.

The receiving unit 47 is configured to receive a virtual device image size switching instruction, where the switching instruction carries size information of a switched virtual device.

The acquiring unit 41 is further configured to acquire a virtual device image corresponding to the size information from the preset storage location.

To the embodiments of the present disclosure, the preset storage location further saves model marking information respectively corresponding to virtual device images having different preset sizes.

The receiving unit 47 is further configured to receive a virtual device image model switching instruction, where the switching instruction carries model marking information of a switched virtual device.

The acquiring unit 41 is further configured to acquire a virtual device image corresponding to the model marking information of the virtual device from the preset storage location.

It is to be noted that reference can be made to corresponding description of the method as shown in FIG. 2 for other corresponding description of various function units involved with the apparatus for displaying a virtual device image provided by embodiments of the present disclosure, which is not unnecessarily elaborated any more herein.

Another apparatus for displaying a virtual device image provided by embodiments of the present disclosure first of all acquires live-action data corresponding to a placement location of a virtual device image and a data display characteristic value corresponding to the live-action data, then determines whether a preset data display characteristic value exists in a preset storage location, where a similarity between the data display characteristic value and the preset data display characteristic value is less than or equal to a preset threshold, acquires a virtual device image having a preset size corresponding to the preset data display characteristic value from the preset storage location when the preset data display characteristic value exists, and finally carries out a superposition display of the live-action data and the virtual device image and displays preset size information corresponding to the virtual device image. Compared with artificially inquiring a seller of a size of a to-be-configured television set on an online store or a physical store at present, in the embodiments of the present disclosure, a virtual television image matched with a current scene size is automatically acquired, and a superposed effect and a specific size are presented, in this way, a device size configuration precision can be improved and unnecessary waste of resources can be reduced.

Further, an embodiment of the present disclosure further provides a non-transitory computer-readable storage medium storing executable instructions, which can be executed by an electronic device to perform any methods for displaying a virtual device image mentioned by embodiments of the present disclosure.

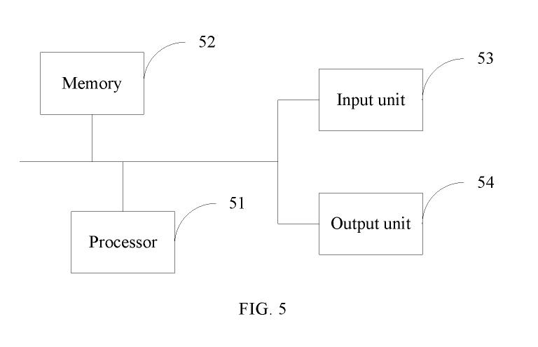

FIG. 5 is a block diagram of an electronic device which is configured to perform the methods for displaying a virtual device image according to an embodiment of the present disclosure. As shown in FIG. 5, the device includes:

one or more processors 51 and memory 52. A processor 51 is showed in FIG. 5 for an example.

Device which is configured to perform the methods for displaying a virtual device image can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for displaying a virtual device image mentioned by embodiments of the present disclosure (such as shown in FIG. 3, acquiring unit 31, determining unit 32 and display unit 33). Processor 51 performs kinds of functions and displaying a virtual device image of the electronic device by executing non-transitory software program, instructions and modules which are stored in memory 52, thereby realizes the methods for displaying a virtual device image mentioned by embodiments of the present disclosure.

Memory 52 can include program storage area and data storage area, thereby the operating system and applications required by at least one function can be stored in program storage area and data created by using the device for displaying a virtual device image can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for displaying a virtual device image by networks. The examples of said networks are including but not limited to Internet, Intranet, LAN, mobile Internet and their combinations.

Input unit 53 can be used to receive inputted number, character information and key signals causing user configures and function controls of the device for displaying a virtual device image. Output unit 54 can include a display screen or a display device.

The said module or modules are stored in memory 52 and perform the methods for displaying a virtual device image when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for displaying a virtual device image, implemented by an electronic device, comprising:
acquiring live-action data corresponding to a placement location of a virtual device image and a data display characteristic value corresponding to the live-action data;
determining whether a preset data display characteristic value exists in a preset storage location, wherein a similarity between the data display characteristic value and the preset data display characteristic value is less than or equal to a preset threshold, and the preset storage location saves different preset data display characteristic values and virtual device images having different preset sizes respectively corresponding to the different preset data display characteristic values;
acquiring a virtual device image having a preset size corresponding to the preset data display characteristic value from the preset storage location when the preset data display characteristic value exists; and
carrying out a superposition display of the live-action data and the virtual device image and displaying preset size information corresponding to the virtual device image.

2. The method for displaying a virtual device image according to claim 1, wherein before the acquiring live-action data corresponding to a placement location of a virtual device image, the method further comprises:
configuring virtual device images having different preset sizes respectively corresponding to different preset data display characteristic values; and
respectively saving the virtual device images having different preset sizes respectively corresponding to different preset data display characteristic values in the preset storage location.

3. The method for displaying a virtual device image according to claim 1, wherein before the carrying out a superposition display of the live-action data and the virtual device image, the method further comprises:
adjusting the virtual device image according to the data display characteristic value corresponding to the live-action data and shooting angle information corresponding to the live-action data.

4. The method for displaying a virtual device image according to claim 3, wherein the carrying out a superposition display of the live-action data and the virtual device image comprises:
carrying out a superposition display of the live-action data and the adjusted virtual device image.

5. The method for displaying a virtual device image according to claim 1, wherein the method further comprises:
receiving a virtual device image size switching instruction, wherein the switching instruction carries size information of a switched virtual device;
acquiring a virtual device image corresponding to the size information from the preset storage location; and
carrying out a superposition display of the live-action data and the virtual device image.

6. The method for displaying a virtual device image according to claim 1, wherein the preset storage location further saves model marking information respectively corresponding to virtual device images having different preset sizes, and the method further comprises:
receiving a virtual device image model switching instruction, wherein the switching instruction carries model marking information of a switched virtual device;
acquiring a virtual device image corresponding to the model marking information of the virtual device from the preset storage location; and
carrying out a superposition display of the live-action data and the virtual device image.

7. A non-transitory computer-readable storage medium storing executable instructions, wherein the executable instructions are configured to:
acquire live-action data corresponding to a placement location of a virtual device image and a data display characteristic value corresponding to the live-action data;
determine whether a preset data display characteristic value exists in a preset storage location, wherein a similarity between the data display characteristic value and the preset data display characteristic value is less than or equal to a preset threshold, and the preset storage location saves different preset data display characteristic values and virtual device images having different preset sizes respectively corresponding to the different preset data display characteristic values;
acquire a virtual device image having a preset size corresponding to the preset data display characteristic value from the preset storage location when the preset data display characteristic value exists; and
carry out a superposition display of the live-action data and the virtual device image and display preset size information corresponding to the virtual device image.

8. The non-transitory computer-readable storage medium according to claim 7, wherein before the step to acquire live-action data corresponding to a placement location of a virtual device image, the executable instructions are further configured to:
configure virtual device images having different preset sizes respectively corresponding to different preset data display characteristic values; and
respectively save the virtual device images having different preset sizes respectively corresponding to different preset data display characteristic values in the preset storage location.

9. The non-transitory computer-readable storage medium according to claim 7, wherein before the step to carry out a superposition display of the live-action data and the virtual device image, the executable instructions are further configured to:
adjust the virtual device image according to the data display characteristic value corresponding to the live-action data and shooting angle information corresponding to the live-action data.

10. The non-transitory computer-readable storage medium according to claim 9, wherein the step to carry out a superposition display of the live-action data and the virtual device image comprises:
carrying out a superposition display of the live-action data and the adjusted virtual device image.

11. The non-transitory computer-readable storage medium according to claim 7, wherein the executable instructions are further configured to:
receive a virtual device image size switching instruction, wherein the switching instruction carries size information of a switched virtual device;
acquire a virtual device image corresponding to the size information from the preset storage location; and
carry out a superposition display of the live-action data and the virtual device image.

12. The non-transitory computer-readable storage medium according to claim 7, wherein the preset storage location further saves model marking information respectively corresponding to virtual device images having different preset sizes, and the executable instructions are further configured to:
receive a virtual device image model switching instruction, wherein the switching instruction carries model marking information of a switched virtual device;
acquire a virtual device image corresponding to the model marking information of the virtual device from the preset storage location; and
carry out a superposition display of the live-action data and the virtual device image.

13. An electronic device, comprising:
at least one processor; and
a memory communicably connected with the at least one processor for storing instructions executable by the at least one processor, wherein execution of the instructions by the at least one processor causes the at least one processor to:
acquire live-action data corresponding to a placement location of a virtual device image and a data display characteristic value corresponding to the live-action data;
determine whether a preset data display characteristic value exists in a preset storage location, wherein a similarity between the data display characteristic value and the preset data display characteristic value is less than or equal to a preset threshold, and the preset storage location saves different preset data display characteristic values and virtual device images having different preset sizes respectively corresponding to the different preset data display characteristic values;
acquire a virtual device image having a preset size corresponding to the preset data display characteristic value from the preset storage location when the preset data display characteristic value exists; and
carry out a superposition display of the live-action data and the virtual device image and display preset size information corresponding to the virtual device image.

14. The electronic device according to claim 13, wherein before the step to acquire live-action data corresponding to a placement location of a virtual device image, the instructions are executed to cause the at least one processor to:
configure virtual device images having different preset sizes respectively corresponding to different preset data display characteristic values; and
respectively save the virtual device images having different preset sizes respectively corresponding to different preset data display characteristic values in the preset storage location.

15. The electronic device according to claim 13, wherein before the step to carry out a superposition display of the live-action data and the virtual device image, the instructions are executed to cause the at least one processor to:
adjust the virtual device image according to the data display characteristic value corresponding to the live-action data and shooting angle information corresponding to the live-action data.

16. The electronic device according to claim 15, wherein the step to carry out a superposition display of the live-action data and the virtual device image comprises:
carrying out a superposition display of the live-action data and the adjusted virtual device image.

17. The electronic device according to claim 13, wherein the instructions are executed to cause the at least one processor to:
receive a virtual device image size switching instruction, wherein the switching instruction carries size information of a switched virtual device;
acquire a virtual device image corresponding to the size information from the preset storage location; and
carry out a superposition display of the live-action data and the virtual device image.

18. The electronic device according to claim 13, wherein the preset storage location further saves model marking information respectively corresponding to virtual device images having different preset sizes, and the instructions are executed to cause the at least one processor to:
receive a virtual device image model switching instruction, wherein the switching instruction carries model marking information of a switched virtual device;
acquire a virtual device image corresponding to the model marking information of the virtual device from the preset storage location; and
carry out a superposition display of the live-action data and the virtual device image.
